(19) United States
(12) Patent Application Publication
(10) Pub. No.: US 2007/0209512 A1
(43) Pub. Date: Sep. 13, 2007

(54) Method of regenerating liquid desiccants used in the dehydration or sweetening of gases

(76) Inventor: Brian Howard Seibert, Stony Plain (CA)

Correspondence Address: DAVIS & BUJOLD, P.L.L.C., 112 PLEASANT STREET, CONCORD, NH, 03301, US

(21) Appl. No.: 11/715,277

(22) Filed: Mar. 7, 2007

Related U.S. Application Data
(60) Provisional application No. 60/779,959, filed on Mar. 7, 2006.

(51) Int. Cl. B01D 53/14

(52) U.S. Cl. 95/193; 95/209

(57) ABSTRACT

A method of regenerating liquid desiccant used in the dehydration or sweetening of gases. A first step involves boiling wet liquid desiccant containing water to create lean liquid desiccant. A second step involves introducing the lean liquid desiccant via a liquid seal pot into a water exhausting stripping column. The hot lean liquid desiccant cascades down the stripping column and evolving equilibrium vapors rise up the stripping column. A third step involves directing the rising equilibrium vapor into a condenser in which the vapor undergoes cooling with a resulting phase change back to liquid. The phase change from vapor to liquid reduces pressure in the condenser, which draws more evolving vapor from the lean liquid desiccant cascading down the stripping column upwards into the condenser, thereby further reducing the water content of the lean liquid desiccant to create a very lean liquid desiccant.

This application claims priority from U.S. Provisional Application Ser. No. 60/79,959 filed Mar. 7, 2006 and U.S. application Ser. No. 11/506,400 filed Aug. 18, 2006.

### FIELD

The present application relates to a method of regenerating liquid desiccants used in the dehydration of gases, for the purpose of drying or sweetening natural gas or other gases.

### BACKGROUND

Liquid desiccants such as mono-, di- and tri-ethylene glycols were first employed in the 1950's to dry natural gases in order to reduce corrosion of pipelines and to prevent the formation of gas hydrates that would block pipelines. Regeneration of the liquid desiccants was accomplished by heating the glycol in a reboiler and purifying same in a distillation column to a glycol purity of up to 98.5% which allowed the gas to be dried to a water content of about 10 lbs water per million standard cubic feet of gas. The introduction of sparging natural gas into the reboiler in the late 1950's and early 1960's allowed regeneration systems to attain a glycol purity of 99.4% that allowed the gas to be dried to a water content of about 7 lbs water per MMSCF.

In 1963 Willy Stahl invented the natural gas stripping column (U.S. Pat. No. 3,105,748) for Parkersburg Rig & Reel, and Black, Sivals and Bryson Inc. liked the idea so much they bought the company. The introduction of a gas stripping column for polishing the glycol after reboiling allowed regeneration systems to attain a glycol purity of 99.9% for a resultant gas water content of under 4 lbs per MMSCF which was a specification employed in areas with colder climates where hydrate formation and water condensation in pipelines was more problematic. But the problem with the Stahl column remains that significant quantities of stripping gas are lost to atmosphere with the reboiled distillation column overheads steam.

In 1971 Laurence S. Reid of Norman Okla. invented an improved process of regenerating liquid desiccant using a water exhauster (U.S. Pat. No. 3,589,984) whereby a cooling coil (or “Coldfinger”) was introduced into the glycol accumulator in order to provide a purer glycol by condensing additional water out of the vapor space of said accumulator with the liquid water being rejected back to the reboiler. Although the water dewpoint depressions were not extreme, further patents by Reid exhibited greater gas drying potential. In 1982 Laurence Reid invented an improved water exhausting process (U.S. Pat. No. 4,332,643) that provided a simpler and more commercially acceptable cooling coil arrangement. This process allowed regeneration systems to attain a glycol purity of 99.96% for a resultant gas water content of approximately 4#/MMSCF.

In 2002 Benoit Landreau and Jean-Claude Amande of the Prosernat company of France patented a modified “Coldfinger” process using a cool glycol spray in the water exhauster vapor space to remove additional equilibrium water vapor (U.S. Pat. No. 6,461,413B1). Glycol purities of 99.99% with a resultant gas water content as low as 2#/MMSCF became attainable.

### SUMMARY

There is provided a method of regenerating liquid desiccant used in the dehydration or sweetening of gases. A first step involves boiling wet liquid desiccant containing water to create lean liquid desiccant with a reduced water content. A second step involves introducing the lean liquid desiccant via a liquid seal pot into a water exhausting stripping column. The hot lean liquid desiccant cascades down the stripping column and evolving equilibrium vapors rise up the stripping column. A third step involves directing the rising equilibrium vapor into a condenser in which the vapor undergoes cooling with a resulting phase change back to liquid. The phase change from vapor to liquid reduces pressure in the condenser, which draws more evolving vapor from the lean liquid desiccant cascading down the stripping column upwards into the condenser, thereby further reducing the water content of the lean liquid desiccant to create a very lean liquid desiccant. A fourth step involves removing the very lean liquid desiccant for recirculation and removing the liquid condensed from the vapor for further processing.

### BRIEF DESCRIPTION OF THE DRAWINGS

These and other features will become more apparent from the following description in which reference is made to the appended drawing, the drawing is for the purpose of illustration only and is not intended to be in any way limiting, wherein:

FIG. 1 is a schematic drawing of a natural gas dehydration unit employing a liquid desiccant regeneration system.

### DETAILED DESCRIPTION

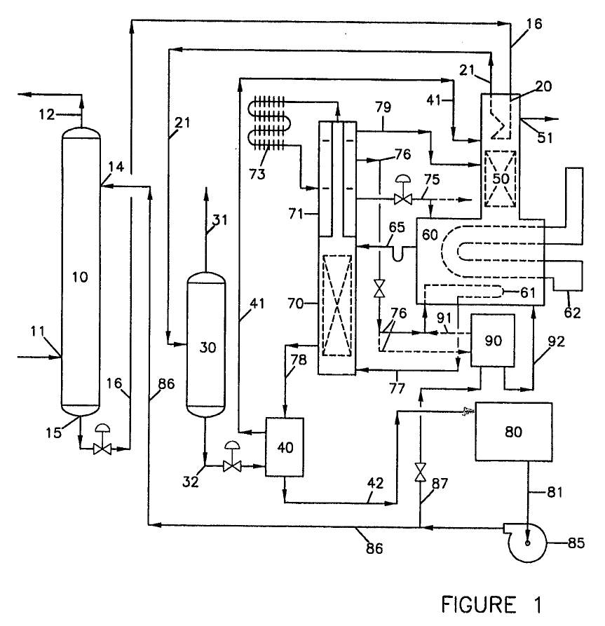

The preferred method will now be described with reference to FIG. 1.

The drying of natural or other gases takes place in the gas/liquid desiccant countercurrent contactor 10 with the relatively high pressure wet gas entering the lower side of the contactor at inlet 11 and the dried gas exiting the top of the contactor at outlet 12. Lean or dry hygroscopic liquid desiccant enters the upper side of the contactor at inlet 14 and rich or wet liquid desiccant leaves the bottom of the contactor at outlet 15.

Rich liquid desiccant is level controlled from the contactor through line 16 to the still column condensing coil 20, where the cooling effect of the relatively cold liquid desiccant condenses reflux water out of the distillation column 50 overhead steam to minimize overheads liquid desiccant vaporization losses. Optionally, the now warm rich liquid desiccant flow through line 21 to the liquid desiccant flash separator 30 where absorbed soluble gases are flashed off and directed from the regeneration system through line 31.

Rich liquid desiccant is level controlled from the liquid desiccant flash separator 30 through line 32 to the rich/lean liquid desiccant heat exchanger 40, by which rich liquid desiccant is heated and lean liquid desiccant is cooled, and the now hot rich liquid desiccant is directed through line 41 to the top of the liquid desiccant distillation (still) column 50, for primary regeneration.

Rich liquid desiccant flows down the still column 50, which may be equipped with a packed, trayed or otherwise devised countercurrent contacting section, and counter-currently contacts lean liquid desiccant and water vapors and the heat from said contact strips the water from the downflowing desiccant. The vaporized water rises up the still column and is directed through line 51 to atmosphere or to a thermal oxidizer or to an overheads condenser for further processing. In the latter case, the condensed steam and any condensed and non-condensed process vapors may be directed to an overhead separator from which the water is directed to a disposal tank, the process liquid, hydrocarbon or otherwise, to a storage tank for commercial sales, and the non-condensable process gases, hydrocarbon or otherwise, may be directed to a sweetener, an incinerator or both, or to the reboiler burner system 62 or to atmosphere as process and environmental conditions warrant.

The now lean liquid desiccant exits the bottom of the still column 50 and enters the liquid desiccant reboiler 60, by which heat is added to the process to develop the desiccant vapors required in the still column reaction, and the lean desiccant is liquid seal or level controlled from the reboiler 60 through line 65 to the water exhausting stripping column 70. The stripping column 70 may be external to the reboiler 60 but is preferably mounted vertically through the reboiler 60 so that the stripping column 70 is immersed in hot liquid desiccant to make up for heat lost in the process of vaporizing further water via the water leaning process in the stripping column 70. Heat may be added to the liquid desiccant reboiler 60 via a direct-fueled firetube 62, an electric heating coil, heat transfer medium or by other such devices.

The lean liquid desiccant enters the top of the stripping column 70, which may be equipped with one or more packed, trayed or otherwise devised countercurrent contacting sections, and flows down, generating water rich desiccant vapors, which absorb the remaining traces of water from the lean liquid desiccant, which then exits the bottom of the stripper. The rising moisture laden condensable vapors flow up an annulus of the stripping medium/water separator 71 (optional), and are directed to an overhead condensing coil 73, where the desiccant and absorbed water vapors are condensed into liquids. The condensed liquids enter midpoint into the side of the stripping medium/water separator 71, and the liquid gravity settles to the bottom of the separator 71, where it is level controlled back to the reboiler 60 or to a disposal tank through line 75, and non-condensable vapor rises to the top of the separator 71 where it accumulates and is drawn by thermal draft at a set flow rate through line 76 to the reboiler stripping medium heating coil 61 prior to reintroduction through line 77 to the stripping column 70. Excess non-condensable gas may be drawn off or consumed gas may be made up, from an optional gas blanketing system (not shown) provided on desiccant accumulator 80.

Very lean liquid desiccant then flows from the stripping column 70 through line 78 to the lean/rich liquid desiccant exchanger 40, by which it is cooled, and on through line 42 to the liquid desiccant accumulator 80. Very lean liquid desiccant then flows from the accumulator 80 through line 81 to the liquid desiccant recirculation pump 85, by which it is re-injected via line 86 to the top of the gas/liquid desiccant countercurrent contactor 10, thus completing a full regeneration circuit.

In a further embodiment of the present invention a gas/liquid membrane contactor 90 may be added into the regeneration system whereby non-condensable gas thermal draft flows or is pumped to the shellside of the membrane contactor through alternate line 76 and a slipstream of lean liquid desiccant flows from the desiccant recirculating pump 85 discharge through line 87 to the tubeside of the membrane contactor and the lean liquid desiccant absorbs any water vapor that may be present in the non-condensable gas, which then continues its circuit through alternate line 91 to the stripping medium heating coil 61 as previously described. The spent liquid desiccant is then returned through line 92 to the liquid desiccant reboiler 60 for regeneration.

The present method provides an improved and simplified method of distillation and water exhaustive stripping of gas drying and sweetening liquid desiccants. The improved method still utilizes a reboiler and distillation column to remove the bulk of liquid water absorbed by the liquid desiccant, but it employs a liquid or valve seal between the reboiler and a polishing vapor stripping column in which the lean descending liquid desiccant generates equilibrium desiccant/water vapor in its vapor space the water laden desiccant vapor rises up an internal conduit of a separation chamber mounted above the stripping column to a condensing coil where the desiccant and water vapors are liquefied and introduced into said upper separation chamber. The liquid settles to the bottom of the chamber and is level controlled and gravity fed to a water disposal tank or back into the reboiler as the process warrants. The very lean liquid desiccant exits the vapor stripping column for further use as a gas drying desiccant.

The present method regenerates a hygroscopic liquid desiccant to a low moisture content, allowing for the attainment of low water contents of natural or other gases without the utilization of condensable or non-condensable stripping vapor, which is often vented to atmosphere, although this water exhaustive liquid desiccant regeneration system may also be designed to operate either with condensable hygroscopic vapor or non-condensable stripping gas in the stripping column as operating, process and environmental circumstances warrant. Besides eliminating costly stripping gas losses or the inefficiencies inherent in the use of a condensable hygroscopic stripping vapor, water exhaustive stripping allows for the improved recovery of desiccant absorbed hydrocarbons such as propane, butane and pentane plus liquids and, in particular, condensable BTEX hydrocarbons such as benzene, toluene, ethyl benzene and xylene. These vaporized liquids and gases are difficult to condense in the presence of methane stripping gas, so the utilization of a condensable hygroscopic stripping medium or water exhaustive stripping process becomes imperative when recovering desiccant absorbed liquid hydrocarbon products. This is accomplished by condensing the overheads of the distillation column, consisting mainly of steam but also quantities of condensable hydrocarbons and, in some cases, non-condensable gases and separating same in a three phase separation vessel into water for disposal, hydrocarbon liquids for further processing or sale and non-condensable gases, if present, for thermal oxidation or venting.

The present method regenerates a hygroscopic liquid desiccant to a low moisture content by employing very high water exhaustive stripping column cooling rates without the accompanying high liquid desiccant losses in the effluent water by reintroducing the rejected stripping column water back to the reboiler for further distillation. This recovery of liquid desiccant within the water stripping circuit allows for the utilization of low vapor pressure desiccants such as monoethylene glycol at high purities for the attainment of high water dew point depression of natural or other gases while minimizing desiccant absorption of unwanted gases such as BTEX, Hydrogen Sulphide and other deleterious components that might be present in the gas stream being treated. Conversely, this same inherent recovery of liquid desiccant losses allows for the full or partial use of sweetening agents such as MEA, DEA or MDEA in conjunction with or as a hygroscopic liquid desiccant to accomplish both gas drying and sweetening simultaneously.

The present method introduces a slipstream of the regenerated liquid desiccant into contact with the non-condensable gases evolved in the water exhaustive stripping column either directly in a countercurrent contactor followed by gravity separation, or indirectly through a gas/liquid membrane contactor in order to remove any water vapor remaining in the non-condensable gases prior to reintroduction to the stripping column vapor space. The wetted glycol slipstream is then returned to the reboiler. This final dehydrating device would allow for gas water dew point depressions suitable for semi-cryogenic gas treating.

The present method operates the regeneration and stripping systems below, at or above atmospheric pressure should process conditions so warrant. Because the primary reboiling system is separated from the final water exhausting stripping circuit by a valve or liquid seal, the reboiler may be operated at higher or lower relative pressures than the stripping column to suit specific process requirements.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope defined in the Claims.

What is claimed is:

1. A method of regenerating liquid desiccant used in the dehydration or sweetening of gases; comprising the steps of:
boiling wet liquid desiccant containing water to create lean liquid desiccant with a reduced water content;
introducing the lean liquid desiccant via a liquid seal pot into a water exhausting stripping column, the hot lean liquid desiccant cascading down the stripping column and evolving equilibrium vapors rising up the stripping column;
directing the rising equilibrium vapor into a condenser in which the vapor undergoes cooling with a resulting phase change back to liquid; the phase change from vapor to liquid reducing pressure in the condenser which draws more evolving vapor from the lean liquid desiccant cascading down the stripping column upwards into the condenser, thereby further reducing the water content of the lean liquid desiccant to create a very lean liquid desiccant;
removing the very lean liquid desiccant for recirculation and removing the liquid condensed from the vapor for further processing.

2. The method of claim 1, the water exhausting stripping column operating with a condensable hygroscopic stripping vapor.

3. The method of claim 1, the water exhaustive stripping column operating with a non-condensable stripping gas.

4. The method of claim 1, the water exhaustive stripping column switching from one stripping medium to another stripping medium during the regeneration process.
